(19) United States
(12) Patent Application Publication
(10) Pub. No.: US 2014/0085038 A1
(43) Pub. Date: Mar. 27, 2014

(54) ELECTRONIC COMPONENT

(71) Applicant: MURATA MANUFACTURING CO., LTD., Kyoto (JP)

(72) Inventor: Keisuke IWASAKI, Kyoto-fu (JP)

(73) Assignee: MURATA MANUFACTURING CO., LTD., Kyoto (JP)

(21) Appl. No.: 14/093,275

(22) Filed: Nov. 29, 2013

Related U.S. Application Data
(63) Continuation of application No. PCT/JP2012/075825, filed on Oct. 4, 2012.

(30) Foreign Application Priority Data
Oct. 14, 2011 (JP) 2011-226606

(51) Int. Cl. H01F 27/255; H01F 27/28

(52) U.S. Cl. CPC H01F 27/255; H01F 27/2804
USPC 336/221

(57) ABSTRACT

An electronic component has a laminate formed by laminating a first insulator layer having a first relative permeability and a second insulator layer having a second relative permeability lower than the first relative permeability. The laminate has a solid shape with first and second end surfaces positioned at opposite ends in a direction of lamination and at least one side surface connecting the first and second end surfaces. A coil is in the laminate and has a coil axis extending along the direction of lamination. The coil is exposed at the at least one side surface of the laminate. A first external electrode is provided on the first end surface. A first connection connects the first external electrode and the coil. The second insulator layer is provided between the coil and the first end surface in the direction of lamination.

### CROSS-REFERENCE TO RELATED APPLICATIONS

This application claims priority to Japanese Patent Application No. 2011-226606 filed on Oct. 14, 2011, and to International Patent Application No. PCT/JP2012/075825 filed on Oct. 4, 2012, the entire content of each of which is incorporated herein by reference.

### TECHNICAL FIELD

The technical field relates to electronic components, more particularly to an electronic component having a coil provided therein.

### BACKGROUND

As a conventional electronic component, a laminated coil disclosed in, for example, Japanese Patent No. 3077061 is known. The laminated coil disclosed in Japanese Patent No. 3077061 will be described below. FIG. 8 is a cross-sectional structure view of the laminated coil 500 disclosed in Japanese Patent No. 3077061.

The laminated coil 500 includes a laminate 512, external electrodes 514a and 514b, an insulating resin 518, and a coil L, as shown in FIG. 8. The laminate 512 is in the shape of a rectangular solid formed by laminating a plurality of insulating sheets. The coil L is a helical coil provided in the laminate 512 and formed by connecting a plurality of coil conductor patterns 516. The coil conductor patterns 516 are exposed at side surfaces of the laminate 512, as shown in FIG. 8.

The external electrodes 514a and 514b are provided on end surfaces of the laminate 512, which are located at opposite ends in the direction of lamination, and the external electrodes 514a and 514b are connected to the coil L. The insulating resin 518 is provided on the side surfaces of the laminate 512, so as to cover portions of the coil conductor patterns 516 that are exposed at the side surfaces of the laminate 512.

In the laminated coil 500 thus configured, the coil conductor patterns 516 are provided as far as the exact outer edges of the insulating sheets, so that the coil L can have a large inner diameter. That is, the coil L can have a high inductance value. Moreover, in the laminated coil 500, the side surfaces of the laminate 512 are covered by the insulating resin 518, so that the coil conductor patterns 516 can be prevented from short-circuiting with patterns on a circuit board, etc.

Incidentally, the laminated coil 500 disclosed in Japanese Patent No. 3077061 has an issue in that eddy currents are set up in the external electrodes 514a and 514b, so that the coil L has a lower inductance value at a higher frequency. That is, the laminated coil 500 has an issue in that the inductance value depends on the frequency of a high-frequency signal. More specifically, the laminated coil 500 has a coil axis parallel to the direction of lamination, and the external electrodes 514a and 514b are provided on the end surfaces of the laminated coil 500, which are located at the opposite ends in the direction of lamination. Accordingly, magnetic fluxes generated by the coil L pass through the external electrodes 514a and 514b. In addition, the laminated coil 500 transmits a high-frequency signal therethrough, and therefore, magnetic fields generated by the coil L fluctuate cyclically. As a result, due to fluctuations of the magnetic fields, eddy currents are set up in the external electrodes 514a and 514b, and transformed into thermal energy. Consequently, eddy-current losses are generated in the laminated coil 500, resulting in a reduced inductance value of the coil L. Moreover, the eddy currents increase as the frequency of the high-frequency signal becomes higher, leading to a further reduction in the inductance value. In this manner, in the laminated coil 500, the inductance value depends on the frequency of a high-frequency signal.

### SUMMARY

An electronic component according to an embodiment of the present disclosure includes: a laminate formed by laminating a first insulator layer having a first relative permeability and a second insulator layer having a second relative permeability lower than the first relative permeability, the laminate having a solid shape with first and second end surfaces positioned at opposite ends in a direction of lamination and at least one side surface connecting the first and second end surfaces; a coil provided in the laminate and having a coil axis extending along the direction of lamination, the coil being exposed at the at least one side surface of the laminate; a first external electrode provided on the first end surface; and a first connection that connects the first external electrode and the coil, wherein the second insulator layer is located between the coil and the first end surface in the direction of lamination.

An electronic component according to an embodiment of the present disclosure includes: a laminate formed by laminating a first insulator layer containing Ni and a second insulator layer containing a lesser amount of Ni than the first insulator layer, the laminate having a solid shape with first and second end surfaces positioned at opposite ends in a direction of lamination and at least one side surface connecting the first and second end surfaces; a coil provided in the laminate and having a coil axis extending along the direction of lamination, the coil being exposed at the at least one side surface of the laminate; a first external electrode provided on the first end surface; and a first connection that connects the first external electrode and the coil, wherein the second insulator layer is located between the coil and the first end surface in the direction of lamination.

### BRIEF DESCRIPTION OF THE DRAWINGS

FIG. 1 is an external oblique view of an electronic component according to an exemplary embodiment of the present disclosure.

FIG. 2 is an exploded oblique view of a laminate in the electronic component according to the embodiment.

FIG. 3 is a cross-sectional structural view of the electronic component taken along line A-A of FIG. 1.

FIG. 4A is a diagram illustrating magnetic fluxes generated in the electronic component.

FIG. 4B is a diagram illustrating magnetic fluxes generated in an electronic component according to a comparative example.

FIG. 5 is a cross-sectional structure view of an electronic component according to a first exemplary modification.

FIG. 6 is a cross-sectional structure view of an electronic component according to a second exemplary modification.

FIG. 7 is a graph showing experimentation results.

FIG. 8 is a cross-sectional structural view of a laminated coil disclosed in Japanese Patent No. 3077061.

### DETAILED DESCRIPTION

Hereinafter, an electronic component according to an exemplary embodiment of the present disclosure will be described.

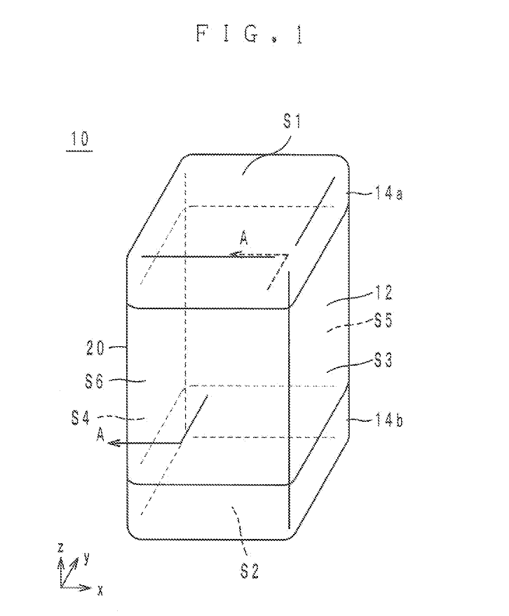

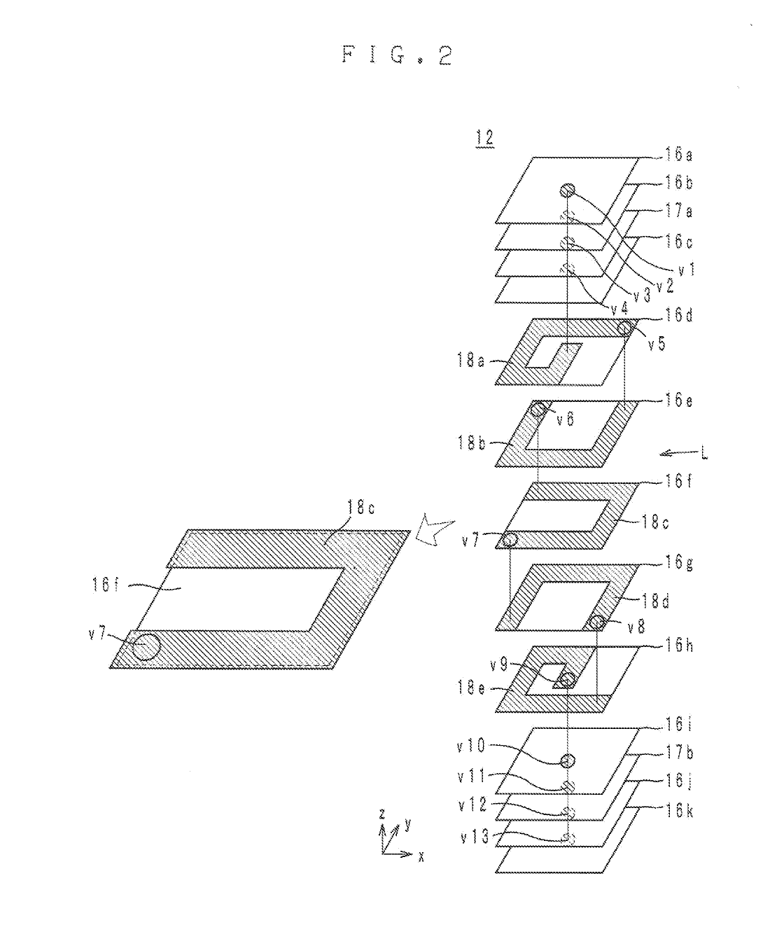

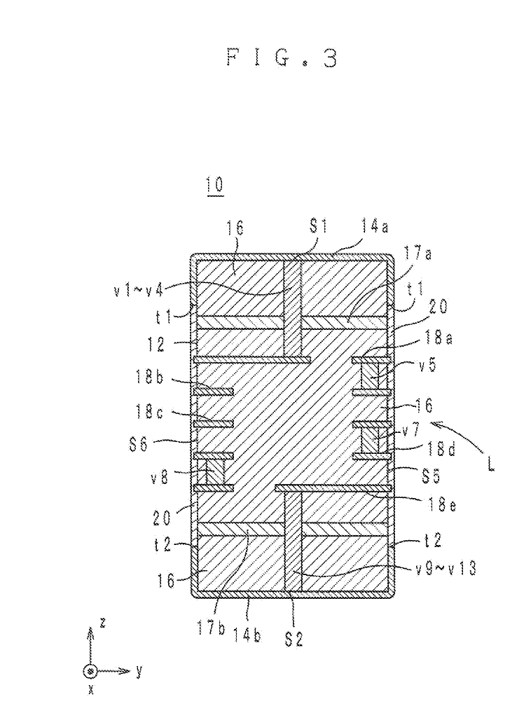

Configuration of Electronic Component: The configuration of the electronic component according to the embodiment of the present disclosure will be described. FIG. 1 is an external oblique view of the electronic component 10 according to the embodiment of the present disclosure. FIG. 2 is an exploded oblique view of a laminate 12 in the electronic component 10 according to the embodiment. FIG. 3 is a cross-sectional structured view of the electronic component 10 taken along line A-A of FIG. 1.

In the following, the direction of lamination of the electronic component 10 will be defined as a z-axis direction, and the directions along two sides of the surface of the electronic component 10 that is located on the positive side in the z-axis direction will be defined as an x-axis direction and a y-axis direction, respectively. The x-axis direction, the y-axis direction, and the z-axis direction are perpendicular to one another.

The electronic component 10 includes the laminate 12, external electrodes 14 (14a and 14b), an insulator film 20, a coil L (not shown in FIG. 1), and via-hole conductors v1 to v4 and v10 to v13, as shown in FIGS. 1 and 2.

The laminate 12 is in the shape of a rectangular solid, for example, and has the coil L provided therein. The laminate 12 has end surfaces S1 and S2 and side surfaces S3 to S6, for example. The end surface S1 is a surface at the end of the electronic component 10 on the positive side in the z-axis direction. The end surface S2 is a surface at the end of the electronic component 10 on the negative side in the z-axis direction. The side surfaces S3 to S6 are surfaces that connect the end surfaces S1 and S2. The side surface S3 is positioned on the positive side in the x-axis direction, the side surface S4 is positioned on the negative side in the x-axis direction, the side surface S5 is positioned on the positive side in the y-axis direction, and the side surface S6 is positioned on the negative side in the y-axis direction.

The external electrodes 14a and 14b are provided on the end surfaces S1 and S2, respectively, of the laminate 12. Moreover, the external electrodes 14a and 14b are bent from the end surfaces S1 and S2, respectively, toward the side surfaces S3 to S6.

The laminate 12 is formed by laminating insulator layers 16a, 16b, 17a, 16c to 16i, 17b, 16j, and 16k in this order, from the positive side toward the negative side in the z-axis direction, as shown in FIG. 2. Each of the insulator layers 16 is a rectangular layer, for example, made of a magnetic material (e.g., Ni—Cu—Zn ferrite; relative permeability μᵣ of 100 to 200). Note that the magnetic material refers to a material that exhibits magnetism at room temperature (relative permeability μᵣ>1). Each of the insulator layers 17 is a rectangular layer, for example, made of a non-magnetic material (e.g., Cu—Zn ferrite or glass). Note that the non-magnetic material refers to a material that exhibits no magnetism at room temperature (relative permeability μᵣ=1). In the following, the surfaces of the insulator layers 16 and 17 on the positive side in the z-axis direction will be referred to as the front faces, and the surfaces of the insulator layers 16 and 17 on the negative side in the z-axis direction will be referred to as the back faces.

The coil L is provided in the laminate 12, and is formed by coil conductor layers 18 (18a to 18e) and via-hole conductors v5 to v8, as shown in FIG. 2. The coil conductor layers 18a to 18e and the via-hole conductors v5 to v8 are connected so that the coil L has a helical form with a coil axis extending in the z-axis direction.

The coil conductor layers 18a to 18e are linear conductor layers provided on the front faces of the insulator layers 16d to 16h, respectively, as shown in FIG. 2, so as to wind rectangularly in a U-like shape slightly protruding from the outer edges of the insulator layers 16d to 16h, as shown in FIG. 3. More specifically, the coil conductor layer 18a makes five eighths of a turn, so as to extend along and protrude from three sides of the insulator layer 16d other than the side that is located on the positive side in the x-axis direction, in a rectangularly winding fashion from the center of the insulator layer 16d (the intersection of the diagonals) to the side of the insulator layer 16d that is located on the negative side in the y-axis direction. Moreover, the coil conductor layer 18a also protrudes from the side of the insulator layer 16d that is located on the positive side in the x-axis direction, at the end on the positive side in the y-axis direction.

Furthermore, each of the coil conductor layers 18b to 18d makes three quarters of a turn along three sides of their respective insulator layers 16e to 16g, so as to protrude from the three sides. Moreover, each of the coil conductor layers 18b to 18d also protrudes from opposite ends of the remaining one side. Specifically, the coil conductor layer 18b extends along and protrudes from three sides of the insulator layer 16e other than the side that is located on the positive side in the y-axis direction. In addition, the coil conductor layer 18b also protrudes from opposite ends of the side that is located on the positive side in the y-axis direction. The coil conductor layer 18c extends along and protrudes from three sides of the insulator layer 16f other than the side that is located on the negative side in the x-axis direction. In addition, the coil conductor layer 18c also protrudes from opposite ends of the side that is located on the negative side in the x-axis direction. The coil conductor layer 18d extends along and protrudes from three sides of the insulator layer 16g other than the side that is located on the negative side in the y-axis direction. In addition, the coil conductor layer 18d also protrudes from opposite ends of the side that is located on the negative side in the y-axis direction.

The coil conductor layer 18e makes five eighths of a turn, so as to extend along and protrude from three sides of the insulator layer 16h other than the side that is located on the positive side in the x-axis direction, in a rectangularly winding fashion from the center of the insulator layer 16h (the intersection of the diagonals) to the side of the insulator layer 16h that is located on the positive side in the y-axis direction. Moreover, the coil conductor layer 18e also protrudes from the side of the insulator layer 16h that is located on the positive side in the x-axis direction, at the end on the negative side in the y-axis direction.

In the following, the ends of the coil conductors 18 that, when viewed in a plan view from the positive side in the z-axis direction, are located upstream in the clockwise direction will be referred to as the upstream ends, and the ends of the coil conductors 18 that, when viewed in a plan view from the positive side in the z-axis direction, are located downstream in the clockwise direction will be referred to as the downstream ends. Note that the coil conductor layers 18 do not necessarily make five eighths or three quarters of a turn. The coil conductor layers 18 may make, for example, a half turn or seven eighths of a turn.

The via-hole conductors v1 to v13 are provided so as to pierce through the insulator layers 16a, 16b, 17a, 16c to 16i, 17b, 16j, and 16k, respectively, in the z-axis direction, as shown in FIG. 2. The via-hole conductors v1 to v4 pierce through the insulator layers 16a, 16b, 17a, and 16c, respectively, in the z-axis direction, and are connected to one another to constitute a single via-hole conductor. The via-hole conductor v1 is connected at the end to the external electrode 14a on the positive side in the z-axis direction, as shown in FIG. 3. Moreover, the via-hole conductor v4 is connected at the end to the upstream end of the coil conductor layer 18a on the negative side in the z-axis direction. As a result, the via-hole conductors v1 to v4 function as a connection between the external electrode 14a and the coil L.

The via-hole conductor v5 pierces through the insulator layer 16d in the z-axis direction, and is connected to the downstream end of the coil conductor layer 18a and the upstream end of the coil conductor layer 18b. The via-hole conductor v6 pierces through the insulator layer 16e in the z-axis direction, and is connected to the downstream end of the coil conductor layer 18b and the upstream end of the coil conductor layer 18c. The via-hole conductor v7 pierces through the insulator layer 16f in the z-axis direction, and is connected to the downstream end of the coil conductor layer 18c and the upstream end of the coil conductor layer 18d. The via-hole conductor v8 pierces through the insulator layer 16g in the z-axis direction, and is connected to the downstream end of the coil conductor layer 18d and the upstream end of the coil conductor layer 18e.

The via-hole conductors v9 to v13 are provided so as to pierce through the insulator layers 16h, 16i, 17b, 16j, and 16k, respectively, in the z-axis direction, and are connected to adjacent via-hole conductors to constitute a single via-hole conductor. The via-hole conductor v9 is connected at the end to the downstream end of the coil conductor layer 18e on the positive side in the z-axis direction. Moreover, the via-hole conductor v13 is connected at the end to the external electrode 14b on the negative side in the z-axis direction, as shown in FIG. 3. As a result, the via-hole conductors v9 to v13 function as a connection between the external electrode 14b and the coil L.

The coil conductor layers 18a to 18e included in the coil L are exposed from the laminate 12 at the side surfaces S3 to S6, as shown in FIG. 3. Moreover, the outer edges of the coil conductor layers 18a to 18e protrude from the side surfaces S3 to S6 of the laminate 12. Note that the outer edges of the coil conductor layers 18a to 18e do not necessarily protrude from the side surfaces S3 to S6 of the laminate 12.

The insulator film 20 is provided so as to cover portions of the side surfaces S3 to S6 of the laminate 12 where the external electrodes 14a and 14b are not provided, as shown in FIGS. 1 and 3. As a result, the portions of the coil L that are exposed from the laminate 12 are covered by the insulator film 20. The insulator film 20 is made of a material different from the magnetic material of the laminate 12, such as epoxy resin.

Here, the positions of the insulator layers 17a and 17b will be described in more detail. In the z-axis direction, the insulator layer 17a is provided between the end surface S1 and the end of the coil L that is located on the positive side in the z-axis direction, as shown in FIG. 3. More specifically, in the electronic component 10 according to the present embodiment, in the z-axis direction, the insulator layer 17a is provided between the end of the coil L that is located on the positive side in the z-axis direction and an edge t1 of the external electrode 14a, which is the periphery of the portion of the external electrode 14a that is bent toward the side surfaces S3 to S6 on the negative side in the z-axis direction. As a result, the insulator layer 17a divides the coil L from the external electrode 14a.

Furthermore, in the z-axis direction, the insulator layer 17b is provided between the end surface S2 and the end of the coil L that is located on the negative side in the z-axis direction, as shown in FIG. 3. More specifically, in the electronic component 10 according to the present embodiment, in the z-axis direction, the insulator layer 17b is provided between the end of the coil L that is located on the negative side in the z-axis direction and an edge t2 of the external electrode 14b, which is the periphery of the portion of the external electrode 14b that is bent toward the side surfaces S3 to S6 on the negative side in the z-axis direction. As a result, the insulator layer 17b divides the coil L from the external electrode 14b.

Method for Producing Electronic Component: The method for producing the electronic component 10 will be described below with reference to the drawings.

Initially, ceramic green sheets from which to make insulator layers 16 are prepared. Specifically, materials weighed at a predetermined ratio, including ferric oxide (Fe₂O₃), zinc oxide (ZnO), nickel oxide (NiO), and copper oxide (CuO), are introduced into a ball mill as raw materials, and subjected to wet mixing. The resultant mixture is dried and ground to obtain powder, which is pre-sintered at 800° C. for 1 hour. The resultant pre-sintered powder is subjected to wet grinding in the ball mill, and thereafter dried and cracked to obtain ferrite ceramic powder.

To the ferrite ceramic powder, a binder (vinyl acetate, water-soluble acrylic, or the like), a plasticizer, a wetting agent, and a dispersing agent are added and mixed in the ball mill, and thereafter defoamed under reduced pressure. The resultant ceramic slurry is spread over carrier sheets by a doctor blade method and dried to form ceramic green sheets from which to make insulator layers 16.

Next, ceramic green sheets from which to make insulator layers 17 are prepared. Specifically, materials weighed at a predetermined ratio, including ferric oxide (Fe₂O₃), zinc oxide (ZnO), and copper oxide (CuO), are introduced into a ball mill as raw materials, and subjected to wet mixing. The resultant mixture is dried and ground to obtain powder, which is pre-sintered at 800° C. for 1 hour. The resultant pre-sintered powder is subjected to wet grinding in the ball mill, and thereafter dried and cracked to obtain ferrite ceramic powder.

To the ferrite ceramic powder, a binder (vinyl acetate, water-soluble acrylic, or the like), a plasticizer, a wetting agent, and a dispersing agent are added and mixed in the ball mill, and thereafter defoamed under reduced pressure. The resultant ceramic slurry is spread over carrier sheets by a doctor blade method and dried to form ceramic green sheets from which to make insulator layers 17.

Next, conductors to serve as via-hole conductors v1 to v13 are provided through their respective ceramic green sheets from which to make insulator layers 16 and 17. Specifically, the ceramic green sheets are irradiated with laser beams to bore via holes therethrough. In addition, a paste made of a conductive material such as Ag, Pd, Cu, Au, or an alloy thereof, is applied by printing or suchlike to fill the via holes, thereby forming the conductors to serve as via-hole conductors v1 to v13.

Next, a paste made of a conductive material is applied by screen printing or photolithography onto the ceramic green sheets from which to make insulator layers 16d to 16h, thereby forming conductors to serve as coil conductors 18 (18a to 18e). The paste made of a conductive material is, for example, Ag powder with varnish and a solvent added thereto. Moreover, the paste used contains a higher proportion of conductive material than normal. Specifically, normal pastes contain 70% by weight of conductive material, but the paste used in the present embodiment contains 80% by weight or more of conductive material.

Note that forming the conductor layers to serve as coil conductor layers 18 (18a to 18e) and filling the via holes with the paste made of a conductive material may be included in the same step.

Next, the ceramic green sheets from which to make insulator layers 16 and 17 are laminated and subjected to pressure-bonding, thereby obtaining an unsintered mother laminate. Specifically, the ceramic green sheets are laminated one by one and subjected to pressure-bonding. Thereafter, the unsintered mother laminate is firmly bonded by isostatic pressing. The isostatic pressing conditions are a pressure of 100 MPa and a temperature of 45° C.

Next, the unsintered mother laminate is cut into discrete unsintered laminates 12. At this stage, the conductor layers to serve as coil conductor layers 18 are exposed at the side surfaces S3 to S6 of the laminates 12, but do not protrude therefrom.

Next, the unsintered laminates 12 are barreled for beveling. Thereafter, each of the unsintered laminates 12 is subjected to debinding and sintering. The debinding is performed, for example, in a low-oxygen atmosphere at 500° C. for two hours. The sintering is performed, for example, at 870° C. to 900° C. for 2.5 hours. Here, the degree of contraction of the ceramic sheets during the sintering differs from the degree of contraction of the conductor layers to serve as coil conductor layers 18 during the sintering. Specifically, the ceramic sheets contract during the sintering more than the conductor layers to serve as coil conductor layers 18. In particular, in the present embodiment, the coil conductor layers to serve as coil conductor layers 18 are made of a paste containing a higher proportion of conductive material than normal. Therefore, the degree of contraction of the conductor layers to serve as coil conductor layers 18 is less than normal. As a result, the coil conductor layers 18 significantly protrude from the side surfaces S3 to S6 of the sintered laminate 12, as shown in FIGS. 2 and 3.

Next, an electrode paste, which is made of a conductive material mainly composed of Ag, is applied to portions of the end surfaces S1 and S2 and the side surfaces S3 to S6 of the laminate 12. Then, the applied electrode paste is baked at a temperature of about 800° C. for one hour. As a result, silver electrodes, which are the bases of external electrodes 14, are formed. Moreover, the silver electrodes are plated with Ni and Sn on their front surfaces, so that the external electrodes 14 are completed.

Lastly, resin such as epoxy is applied to portions of the side surfaces S3 to S6 of the laminate 12 where the external electrodes 14a and 14b are not provided, thereby forming an insulator film 20, as shown in FIG. 3. As a result, the insulator film 20 covers the entire portions of the laminate 12 where the insulator layers 18 are exposed. Thus, the insulator film 20 prevents the coil L from short-circuiting with patterns on a circuit board, etc. By the foregoing process, the electronic component 10 is completed.

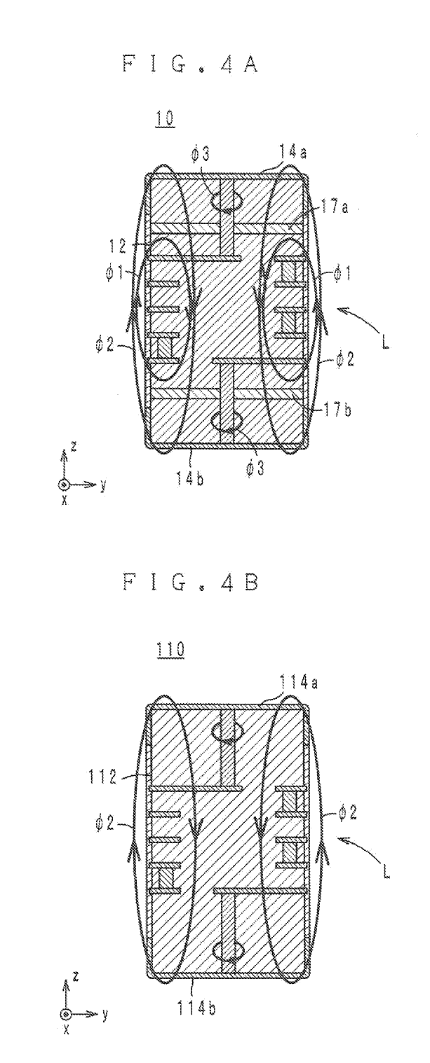

Effects: The electronic component 10 as above renders it possible to reduce the dependence of the inductance value on the frequency of a high-frequency signal. FIG. 4A is a diagram illustrating magnetic fluxes φ1 and φ2 generated in the electronic component 10. FIG. 4B is a diagram illustrating magnetic fluxes φ2 generated in an electronic component 110 according to a comparative example. The electronic component 110 includes insulator layers 16 in place of the insulator layers 17 of the electronic component 10. Note that elements of the electronic component 110 that are the same as in the electronic component 10 are denoted by adding 100 to the reference numbers for the electronic component 10.

In the electronic component 110 according to the comparative example, the magnetic fluxes φ2 generated by the coil L pass through external electrodes 114a and 114b while traveling in large circles around the coil L, as shown in FIG. 4B. The electronic component 110 transmits a high-frequency signal therethrough, and therefore, magnetic fields generated by the coil L fluctuate cyclically. As a result, due to fluctuations of the magnetic fields, eddy currents are set up in the external electrodes 114a and 114b, and transformed into thermal energy. Consequently, eddy-current losses are generated in the electronic component 110, resulting in a reduced inductance value of the coil L. Moreover, the eddy currents increase as the frequency of the high-frequency signal becomes higher, leading to a further reduction in the inductance value. In this manner, in the electronic component 110, the inductance value depends on the frequency of a high-frequency signal.

On the other hand, as for the electronic component 10, in the z-axis direction, the insulator layers 17a and 17b made of a non-magnetic material are provided between the coil L and the end surfaces S1 and S2, respectively. The insulator layers 17a and 17b made of a non-magnetic material are resistant to transmitting magnetic fluxes therethrough. Accordingly, as shown in FIG. 4A, magnetic fluxes φ1, which circle between the insulator layers 17a and 17b without passing through the insulator layers 17a and 17b, relatively increase, and magnetic fluxes φ2, which pass through the insulator layers 17a and 17b and the external electrodes 14a and 14b, relatively decrease. This inhibits eddy currents from being set up at the parts of the external electrodes 14a and 14b that are positioned on the end surfaces S1 and S2 in the electronic component 10, so that the inductance value of the coil L can be inhibited from being reduced. Thus, the electronic component 10 renders it possible to reduce the dependence of the inductance value on the frequency of a high-frequency signal.

Furthermore, in the electronic component 110, the coil L is exposed at the side surfaces S3 to S6 of a laminate 112. Accordingly, as shown in FIG. 4B, magnetic fluxes φ2 exit the laminate 112 through the side surfaces S3 to S6 of the laminate 112, and enter back the laminate 112 through the side surfaces S3 to S6. In this case, the magnetic fluxes φ2 pass through bent portions of the external electrodes 114a and 114b. Therefore, in the electronic component 110, the inductance value of the coil L is reduced due to eddy currents. That is, as for the electronic component 110, it is important to take countermeasures against eddy currents at the bent portions of the external electrodes 114a and 114b.

Therefore, in the electronic component 10, in the z-axis direction, the insulator layers 17a and 17b made of a non-magnetic material are provided between the coil L and the edges t1 and t2, respectively, of the external electrodes 14a and 14b. As a result, the magnetic fluxes φ1, which circle between the insulator layers 17a and 17b without passing through the insulator layers 17a and 17b, relatively increase, and the magnetic fluxes φ2, which pass through the insulator layers 17a and 17b and the external electrodes 14a and 14b, including the bent portions thereof, relatively decrease. This inhibits eddy currents from being set up at the bent portions of the external electrodes 14a and 14b in the electronic component 10, so that the inductance value of the coil L can be inhibited from being reduced. Thus, the electronic component 10 renders it possible to reduce the dependence of the inductance value on the frequency of a high-frequency signal.

Furthermore, in the electronic component 10, the via-hole conductors v1 to v4 and v9 to v13 pierce through the center of the insulator layers 16 and 17 in the z-axis direction. Accordingly, the via-hole conductors v1 to v4 and v9 to v13 are positioned away from the bent portions of the external electrodes 14a and 14b. As a result, magnetic fluxes φ3 generated by the via-hole conductors v1 to v4 and v9 to v13 are less likely to be transmitted through the bent portions of the external electrodes 14a and 14b. This inhibits eddy currents from being set up at the bent portions of the external electrodes 14a and 14b in the electronic component 10, so that the inductance value of the coil L can be inhibited from being reduced. Thus, the electronic component 10 renders it possible to reduce the dependence of the inductance value on the frequency of a high-frequency signal.

Furthermore, in the electronic component 10, the coil L and the external electrodes 14a and 14b are connected through the connections formed by the via-hole conductors v1 to v4 and v9 to v13. At the via-hole conductors v1 to v4 and v9 to v13, the magnetic fluxes φ3 are generated parallel to the xy-plane, so as to circle around the via-hole conductors v1 to v4 and v9 to v13, as shown in FIG. 4A. Accordingly, the magnetic fluxes φ3 are approximately parallel to the insulator layers 17a and 17b, and are less likely to cross the insulator layers 17a and 17b. Therefore, the magnetic fluxes φ3 are not susceptible to being affected by the insulator layers 17a and 17b. As a result, inductance equivalent to the length of the via-hole conductors v1 to v4 and v9 to v13 can be added to the inductance value of the coil L, resulting in a higher inductance value.

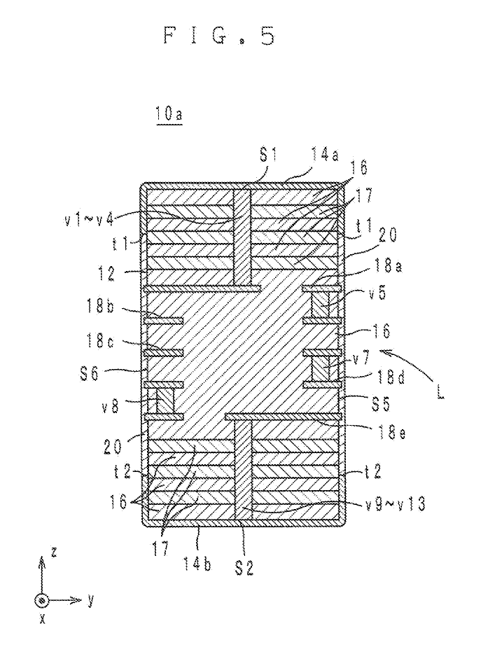

First Modification: An electronic component according to a first modification will be described below with reference to the drawings. FIG. 5 is a cross-sectional structural view of the electronic component 10a according to the first modification.

In the z-axis direction, a plurality of insulator layers 17 can be provided between the end surface S1 and the end of the coil L that is located on the positive side in the z-axis direction, as shown in FIG. 5. Likewise, in the z-axis direction, a plurality of insulator layers 17 can be provided between the end surface S2 and the end of the coil L that is located on the negative side in the z-axis direction. As a result, the magnetic fluxes φ1 are more effectively inhibited from passing through the external electrodes 14a and 14b.

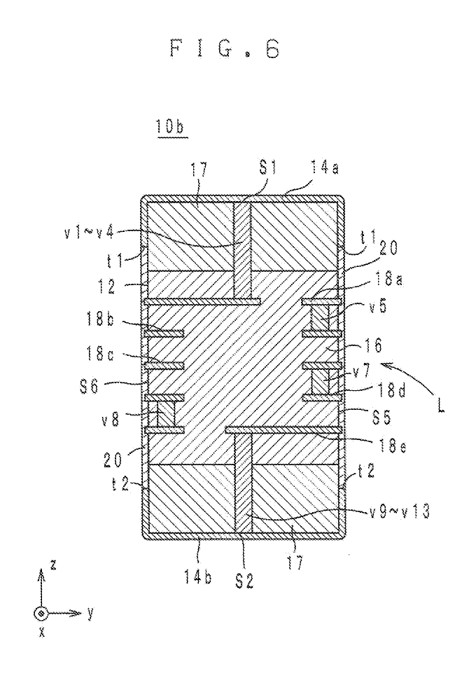

Second Modification: An electronic component according to a second modification will be described below with reference to the drawings. FIG. 6 is a cross-sectional structural view of the electronic component 10b according to the second modification.

An insulator layer 17 can be provided so as to occupy the entire area that spans from a predetermined position to the end surface S1 in the z-axis direction, the predetermined position being between the end of the coil L that is located on the positive side in the z-axis direction and the end surface S1, as shown in FIG. 6. Likewise, an insulator layer 17 can be provided so as to occupy the entire area that spans from a predetermined position to the end surface S2 in the z-axis direction, the predetermined position being between the end of the coil L that is located on the negative side in the z-axis direction and the end surface S2. As a result, the magnetic fluxes φ1 can be more effectively inhibited from passing through the external electrodes 14a and 14b.

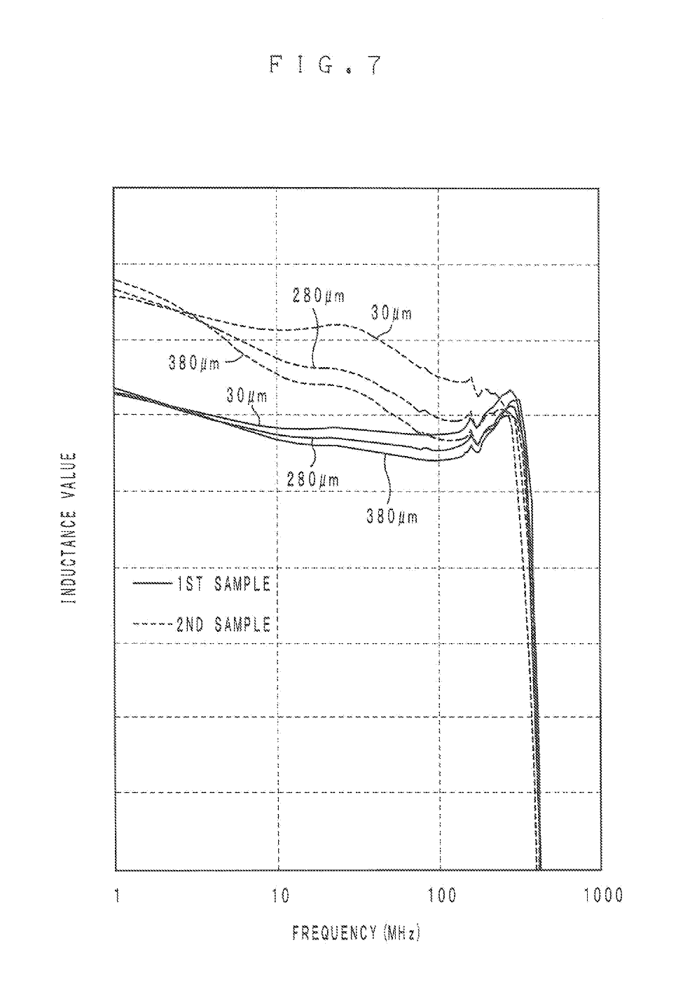

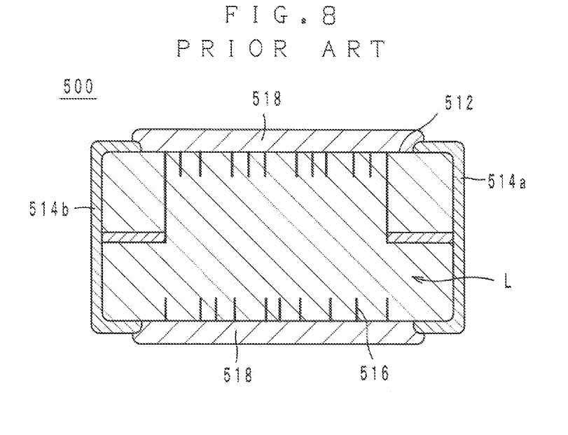

Experimentation: To more clearly demonstrate the effects achieved by the electronic component according to the present disclosure, the present inventor carried out the experimentation to be described below. Specifically, first samples of the electronic component 10b according to the second modification shown in FIG. 6 and second samples of the electronic component 110 according to the comparative example shown in FIG. 4B were produced in order to study the relationship between the frequency of an input signal and the inductance value for each of the samples. In this case, each of the first and second samples was prepared in three different lengths, 30 μm, 280 μm, and 380 μm, of the bent portions of the external electrodes 14a and 14b in the z-axis direction. FIG. 7 is a graph showing the experimentation results. The vertical axis represents the inductance value, and the horizontal axis represents the frequency of an input signal. The specifications for the first and second samples are listed below:
Dimension of the laminate in the z-axis direction: 1.9 mm;
Dimension of the laminate in the y-axis direction: 1.2 mm;
Dimension of the laminate in the x-axis direction: 0.8 mm;
Dimension of the electronic component in the z-axis direction: 2.0 mm;
Dimension of the electronic component in the y-axis direction: 1.25 mm;
Dimension of the electronic component in the x-axis direction: 0.85 mm;
Thickness of the insulator layer 17: 420 μm from the end of the laminate;
Insulator layer 16: Ni—Cu—Zn ferrite (relative permeability μᵣ=120); and
Insulator layer 17: Cu—Zn ferrite (relative permeability μᵣ=1).

In FIG. 7, the electronic component 10b is reduced in inductance value more gently than the electronic component 110 as the frequency of an input signal increases. Specifically, it can be appreciated that, in the frequency range from 1 MHz to 500 MHz, the dependence of the inductance value on the frequency is reduced in the electronic component 10b more than in the electronic component 110.

Furthermore, it can be appreciated from FIG. 7 that the dependence of the inductance value on the frequency increases with the length of the bent portions of the external electrodes 14a, 14b, 114a, and 114b in the z-axis direction. This implies that magnetic fluxes that pass through the bent portions of the external electrodes 14a, 14b, 114a, and 114b increase with the length of the bent portions of the external electrodes 14a, 14b, 114a, and 114b in the z-axis direction, so that more eddy currents are set up at the bent portions of the external electrodes 14a, 14b, 114a, and 114b. Thus, based on the present experimentation, it can be said that by providing the insulator layers 17 in the manner they are provided in the electronic component 10b, the dependence of the inductance value on the frequency can be reduced even if the length of the bent portions of the external electrodes 14a and 14b in the z-axis direction is increased.

### Other Embodiments

The present disclosure is not limited to the electronic components 10, 10a, and 10b according to the above embodiment, and modifications can be made within the spirit and scope of the disclosure.

For example, the insulator layer 17 has been described as being made of a non-magnetic material, but it can be made of a magnetic material, so long as the relative permeability of the insulator layer 17 is lower than the relative permeability of the insulator layer 16.

Note that the methods for producing the electronic components 10, 10a, and 10b are not limited to sequential pressure-bonding methods in which ceramic green sheets with conductor layers to serve as coil conductor layers 18a to 18e provided thereon are laminated and subjected to pressure-bonding before they are sintered as a unit. Accordingly, the electronic components 10, 10a, and 10b may be produced by a printing process to be described below. More specifically, an insulative paste is applied by printing or suchlike to form an insulator layer, and thereafter, a conductive paste is applied to the front face of the insulator layer, thereby forming a conductor layer to serve as a coil conductor layer. Next, an insulative paste is applied onto the conductor layer to serve as a coil conductor layer, thereby completing an insulator layer with the conductor layer to serve as a coil conductor layer provided therein. The above steps are repeated to produce the electronic components 10, 10a, and 10b.

Furthermore, for the electronic components 10, 10a, and 10b, the coil L is not necessarily exposed at all of the side surfaces S3 to S6 of the laminate 12, and may be exposed at a part of the side surfaces S3 to S6. Moreover, all of the coil conductor layers 18a to 18e are not necessarily exposed at the side surfaces S3 to S6, and a part of the coil conductor layers 18a to 18e may be exposed at the side surfaces S3 to S6.

Furthermore, in the electronic components 10, 10a, and 10b, the via-hole conductors v1 to v4 and v9 to v13 pierce through the center of the insulator layers 16 and 17 in the z-axis direction, but they may pierce through other portions of the insulator layers 16 and 17 in the z-axis direction.

Furthermore, the electronic components 10, 10a, and 10b are coil components each having only the coil L provided therein, but they may be combined electronic components each having, in addition to the coil L, a capacitor, a resistor, and other circuit elements provided therein.

Although the present disclosure has been described in connection with the preferred embodiments above, it is to be noted that various changes and modifications are possible to those who are skilled in the art. Such changes and modifications are to be understood as being within the scope of the disclosure.

What is claimed is:

1. An electronic component comprising:
a laminate formed by laminating a first insulator layer having a first relative permeability and a second insulator layer having a second relative permeability lower than the first relative permeability, the laminate having a solid shape with first and second end surfaces positioned at opposite ends in a direction of lamination and at least one side surface connecting the first and second end surfaces;
a coil provided in the laminate and having a coil axis extending along the direction of lamination, the coil being exposed at the at least one side surface of the laminate;
a first external electrode provided on the first end surface; and
a first connection connecting the first external electrode and the coil,
the second insulator layer being located between the coil and the first end surface in the direction of lamination.

2. An electronic component comprising:
a laminate formed by laminating a first insulator layer containing Ni and a second insulator layer containing a lesser amount of Ni than said first insulator layer, the laminate having a solid shape with first and second end surfaces positioned at opposite ends in a direction of lamination and at least one side surface connecting the first and second end surfaces;
a coil provided in the laminate and having a coil axis extending along the direction of lamination, the coil being exposed at the at least one side surface of the laminate;
a first external electrode provided on the first end surface; and
a first connection connecting the first external electrode and the coil,
the second insulator layer being located between the coil and the first end surface in the direction of lamination.

3. The electronic component according to claim 2, wherein
the second insulator layer does not substantially contain Ni.

4. The electronic component according to claim 1, wherein
the first external electrode is bent from the first end surface toward the at least one side surface, and
in the direction of lamination, the second insulator layer is provided between the coil and an edge of a portion of the first external electrode, the portion is bent toward the at least one side surface in the direction of lamination.

5. The electronic component according to claim 1, wherein a plurality of the second insulator layers is provided between the coil and the first end surface in the direction of lamination.

6. The electronic component according to claim 1, wherein the second insulator layer occupies an area from a given level to the first end surface in the direction of lamination, the given level is between the coil and the first end surface.

7. The electronic component according to claim 1, wherein
the first insulator layer is made of a magnetic material, and
the second insulator layer is made of a non-magnetic material.

8. The electronic component according to claim 1, wherein the first connection is formed by via-hole conductors piercing through the first and second insulator layers in the direction of lamination.

9. The electronic component according to claim 1, further comprising:
a second external electrode provided on the second end surface; and
a second connection connecting the second external electrode and the coil.

10. The electronic component according to claim 9, wherein the second insulator layer is provided between the coil and the second end surface in the direction of lamination.

11. The electronic component according to claim 2, wherein
the first external electrode is bent from the first end surface toward the at least one side surface, and
in the direction of lamination, the second insulator layer is provided between the coil and an edge of a portion of the first external electrode, the portion is bent toward the at least one side surface in the direction of lamination.

12. The electronic component according to claim 2, wherein a plurality of the second insulator layers is provided between the coil and the first end surface in the direction of lamination.

13. The electronic component according to claim 2, wherein the second insulator layer occupies an area from a given level to the first end surface in the direction of lamination, the given level is between the coil and the first end surface.

14. The electronic component according to claim 2, wherein
the first insulator layer is made of a magnetic material, and
the second insulator layer is made of a non-magnetic material.

15. The electronic component according to claim 2, wherein the first connection is formed by via-hole conductors piercing through the first and second insulator layers in the direction of lamination.

16. The electronic component according to claim 2, further comprising:
a second external electrode provided on the second end surface; and
a second connection connecting the second external electrode and the coil.
